(19) United States
(12) Patent Application Publication
(10) Pub. No.: US 2026/0280299 A1
(43) Pub. Date: Sep. 17, 2026

(54) ELECTRIC LAWN MOWER CHARGING SYSTEM FOR CONTROLLING CHARGING AND DISCHARGING

(71) Applicant: Honda Motor Co., Ltd., Tokyo (JP)

(72) Inventor: David PERZYNSKI, Signal Hill, CA (US)

(73) Assignee: Honda Motor Co., Ltd., Tokyo (JP)

(21) Appl. No.: 19/076,218

(22) Filed: Mar. 11, 2025

(51) Int. Cl. H02J 3/32; A01D 34/00; A01D 101/00; B60L 53/62; B60L 53/63; B60L 55/00; H02J 3/00; H02J 7/00

(52) U.S. Cl. CPC H02J 3/322; B60L 53/62; B60L 53/63; B60L 55/00; H02J 3/001; H02J 7/92; H02J 7/933; A01D 34/00; A01D 2101/00; B60L 2200/40

(57) ABSTRACT

A method for a charging unit to charge and discharge a battery unit of an electric lawn mower is provided. The method may connect the electric lawn mower to the charging unit. The method may use the battery unit of the electric lawn mower as a bi-directional power source. The charging unit may direct power from the battery unit of the electric lawn mower in a first direction to be used as a back-up power supply for a device and in a second direction back to an electrical grid.

### BACKGROUND

Electric lawn mowers may be used for landscaping. Some electric lawn mowers may operate directly through a connection to an AC power line. These types of electric lawn mowers may have an electrical cord which may be directly connected to the AC power line. The electric lawn mower may need to remain connected to the AC power line while in operation. The use of the electrical cord may limit the range of use of this type of electric lawn mower. During operation, the electric cord may need to be moved to keep the electrical cord from being run over and damaged by the electric lawn mower.

To expand the usage of electric lawn mowers which may need the use of an electrical cord during operation, one may use a cordless battery-electric lawn mower. Battery-electric lawn mowers may have one or more rechargeable batteries powering an electric motor of the battery-electric lawn mower. The batteries may be recharged by connecting the battery-electric lawn mower to a battery charging unit connected to a conventional household outlet or by other charging technologies.

Some individuals may like to have the battery-electric lawn mower fully charged before mowing a lawn. However, to have the battery-electric lawn mower fully charged at all times may require the battery-electric lawn mower to be continuously plugged into the battery charging unit. Continuous charging of the battery of the battery-electric lawn mower may lead to overcharging, which may generate excessive heat and can degrade the lifespan of the battery. Thus, it may be beneficial to provide a smart charging system for the battery-electric lawn mower that may control charging and discharging of the battery of the battery-electric lawn mower and to increase the battery life of the battery-electric lawn mower.

Limitations and disadvantages of conventional and traditional approaches will become apparent to one of skill in the art, through comparison of described system and method with some aspects of the present disclosure, as set forth in the remainder of the present application and with reference to the drawings.

### SUMMARY

According to an embodiment of the disclosure, a method for a charging unit to charge and discharge a battery unit of an electric lawn mower is provided. The method may connect the electric lawn mower to the charging unit. The method may use the battery unit of the electric lawn mower as a bi-directional power source. The charging unit may direct power from the battery unit of the electric lawn mower in a first direction to be used as a back-up power supply for a device and in a second direction back to an electrical grid.

According to another embodiment of the disclosure, a method for a charging unit to charge and discharge a battery unit of an electric lawn mower is provided. The method may connect the electric lawn mower to the charging unit. The method may determine a desired charging level range of the battery unit by the charging unit to prolong a life of the battery unit. The method may schedule a date and time on the charging unit when the lawn mower is to be used for landscaping. The method may enter a landscaping charge level of the battery unit on the charging unit. The method may calculate by the charging unit a charging date and time when to charge the battery unit so the battery unit is charged to the landscaping charge level at the scheduled date and time. The method may charge the battery unit at the calculated charging date and time. The method may determine a current charge level of the battery unit by the charging unit. The method may maintain the current charge level of the battery unit within the desired charging level range by the charging unit unless scheduled for landscaping and to be charged to the landscaping charge level. The method may use the battery unit of the electric lawn mower as a bi-directional power source when the lawn mower is not being used for landscaping, the charging unit directing power from the battery unit of the electric lawn mower in a first direction to be used as a back-up power supply for a device and in a second direction back to an electrical grid.

According to another embodiment of the disclosure, a method for a charging unit to charge and discharge a battery unit of an electric lawn mower is provided. The method may connect the electric lawn mower to the charging unit. The method may schedule a date and time the lawn mower is to be used for landscaping. The method may enter a landscaping charge level of the battery unit on the charging unit. The method may calculate by the charging unit a charging date and time when to charge the battery unit so the battery unit is charged to the landscaping charge level at the scheduled date and time. The method may charge the battery unit at the calculated charging date and time so the battery unit is charged to the landscaping charge level. The method may determine a current charge level of the battery unit by the charging unit. The method may determine a desired charging level range of the battery unit by the charging unit to prolong a life of the battery unit. The method may discharge the battery unit when the current charge level of the battery unit is above the desired charging level range and the date and time for landscaping is above a predetermined timeframe. The method may calculate when the current charge level falls below the desired charging level range by the charging unit. The method may charge the battery unit prior to the current charge level of the battery unit falling below the desired charging level range unless the date and time for landscaping is within a predetermined timeframe. The method may use the battery unit of the electric lawn mower as a bi-directional power source, the charging unit directing power from the battery unit of the electric lawn mower in a first direction to be used as a back-up power supply for a device and in a second direction back to an electrical grid.

### BRIEF DESCRIPTION OF THE DRAWINGS

FIG. 1 shows a block diagram of an exemplary system for controlling charging and discharging of a battery-electric lawn mower, in accordance with an embodiment of the disclosure;

FIG. 2 shows a block diagram of an exemplary battery charging unit used in the system of FIG. 1, in accordance with an embodiment of the disclosure;

FIG. 3 is an exemplary flowchart for controlling the charging and discharging of the battery-electric lawn mower shown in FIG. 1, in accordance with an embodiment of the disclosure

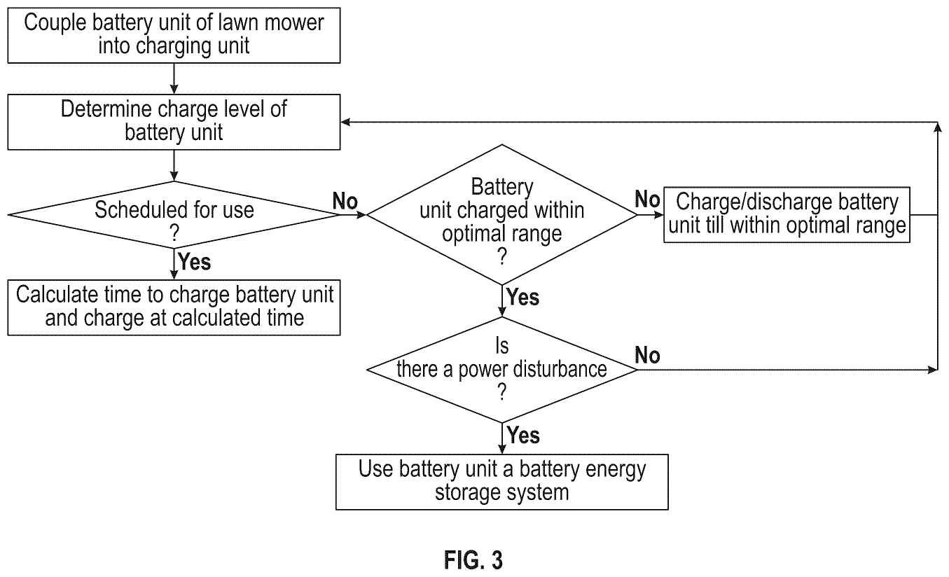

The foregoing summary, as well as the following detailed description of the present disclosure, is better understood when read in conjunction with the appended drawings. For the purposes of illustrating the present disclosure, exemplary constructions of the preferred embodiment are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

### DETAILED DESCRIPTION

Reference will now be made in detail to specific aspects or features, examples of which are illustrated in the accompanying drawings. Wherever possible, corresponding, or similar reference numbers will be used throughout the drawings to refer to the same or corresponding parts.

Exemplary aspects of the disclosure may provide a smart charging system and method for battery-electric lawn mowers. The smart charging system and method for the battery-electric lawn mowers may manage charging and discharging strategies to extend the battery life of the battery-electric lawn mower. The smart charging system and method may use a controller to calculate energy consumption of the battery, charging times and usage to extend usage of the battery-electric lawn mower.

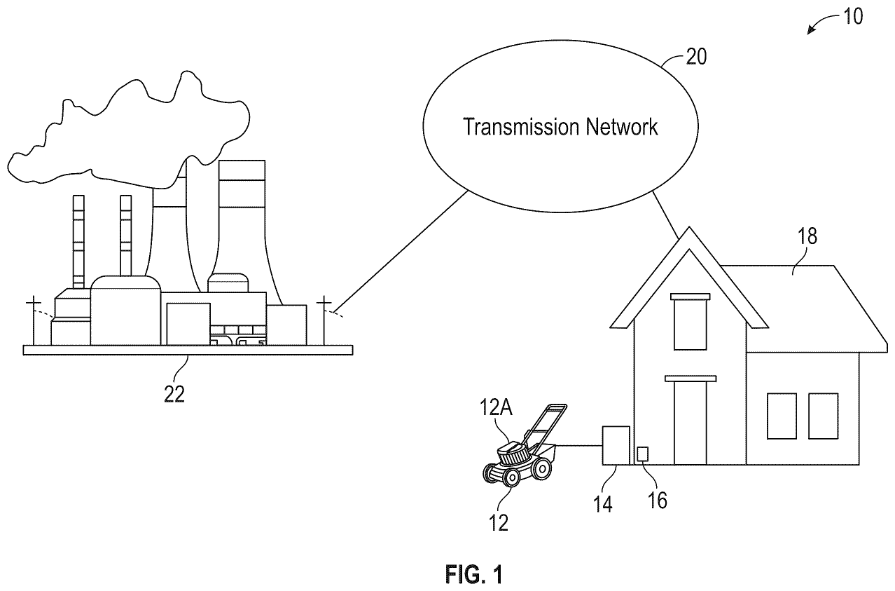

Referring to FIG. 1, an exemplary smart battery-electric lawn mower charging system 10 (hereinafter system 10) may be shown. The system 10 may have a battery-electric lawn mower 12 (hereinafter lawn mower 12). A charging unit 14 may be removably coupled to the lawn mower 12. The charging unit 14 may be used to manage charging and discharging strategies for a battery unit 12A of the lawn mower 12. The charging unit 14 may be used to estimate energy consumption of the battery unit 12A, control charging and discharging of the battery unit 12A to extend usage of the battery unit 12A, provide a fully charged battery unit 12A at a designed time when the lawn mower 12 may be used for landscaping purposes, use the battery unit 12A as a battery energy storage system (BESS), and other features as may be disclosed below. The charging unit 14 may be coupled to an electrical system 16 of a building 18. The electrical system 16 may be used to power the charging unit 14 and/or receive power from the battery unit 12A of the lawn mower 12 when needed. The building 18 may be powered by a utility provider 22 via a transmission network 20.

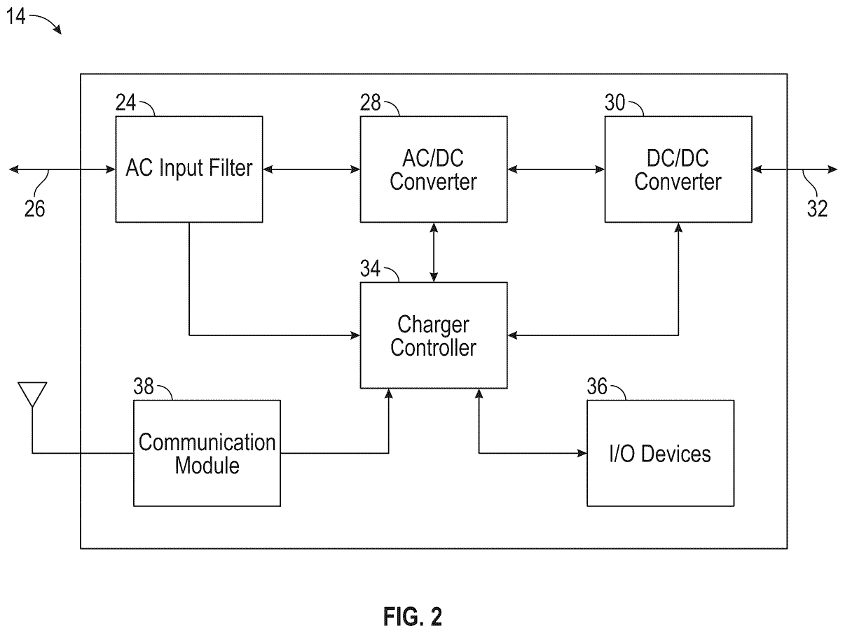

Referring to FIG. 2, the charging unit 14 may have an AC input filter 24. The AC input filter 24 may be used to suppress and filter out electrical noise from an AC power line 26. The filtered AC power may be sent to an AC/DC converter 28. The AC/DC converter 28 may transform the filtered AC power into a direct current (DC) output. The DC output may be sent to a DC/DC converter 30. The DC/DC converter 30 may take the DC output from the AC/DC converter 28 and may convert it to another DC voltage which may be sent over a power line 32 to the battery unit 12A of the lawn mower 12.

The charging unit 14 may have a controller 34. The controller 34 may be used to manage charging and discharging strategies for the battery unit 12A. The controller 34 may be used to calculate energy consumption of the battery unit 12A, control charging and discharging of the battery unit 12A to extend usage of the battery unit 12A, determine when to provide a fully charged battery unit 12A at a designed time when the lawn mower 12 may be used for landscaping purposes, when to use the battery unit 12A as a BESS, and other features as may be disclosed below. Input/Output (I/O) devices 36 may be coupled to the controller 34. The I/O devices 36 may be used to enter and display data of the charging unit 14. For example, the I/O devices 36 may be a keypad, a display, or similar devices to enter data, receive data, and/or display data of the charging unit 14. The charging unit 14 may have a communication device 38. The communication device 38 may allow data exchange between the charging unit 14 and external devices as may be described below.

When the battery unit 12A of the lawn mower 12 is coupled to the charging unit 14 via the power line 32, the charging unit 14 may monitor the current charge level of the battery unit 12A. Based on the current charge level, the charging unit 14 may determine charging and discharging strategies for the battery unit 12A. The charging unit 14 may calculate a desired state of charge for the battery unit 12A. The desired state of charge for the battery unit 12A may be based on varies factors. For example, while the maximum charge level of a typical rechargeable battery may be 100%, the desired charge level for the rechargeable battery unit 12A may be around 20% to 80% of the maximum charge level. Keeping the charge level between the 20%-80% range may enhance the life of the battery unit 12A by minimizing stress on the battery unit 12A during charging cycles. Thus, the charging unit 14 may be used to safeguard that the battery unit 12A, when connected to the charging unit 14, maintains a charge level between the desired charge level range. In the above example, the desired range may be between 20%-80%, which may extend the life of the battery unit 12A.

If the charging unit 14 determines that the current charge level of the battery unit 12A is above the desired charge level range, the charging unit 14 may determine a discharging strategy for the battery unit 14. For example, the charging unit 14 and/or the lawn mower 12 may have a discharge function which may allow the current charge level of the battery unit 12A to be lowered so that it is between the desired range. Once the charge level is within the desired range, the charging unit may discontinue discharging the battery unit 14.

The charging unit 14 may calculate the drain rate of the battery unit 12A and determine when the battery unit 12A may fall below the desired charge level range. Prior to when the battery unit 12A falls below the desired charge level range, the charging unit 14 may be configured to charge the battery unit 12A until the charge level is within the desired range. The charging unit 14 may be configured to keep the battery unit 12A charged within the range of the desired charge level while trying to minimize charging cost. For example, if the charging unit 14 calculates that the battery unit 12A may fall below the desired minimum level during a peak usage time for the utility provider 22, the charging unit 14 may be configured to charge the battery unit 12A at an earlier off-peak usage time for the utility provider 22 to lower charging cost and to lessen the power demand of the utility provider 22. For example, if the charging unit 14 determines that the battery unit 12A may fall below a 20% charge level during a peak usage time of 2:00 pm-7:00 pm of the utility provider 22, the charging unit 14 may begin to charge the battery unit 12A and have the battery unit 12A charged to around an 80% charge level prior to the peak usage time.

Based on the current charge level, the charging unit 14 may calculate and plan when charging of the battery unit 12A should commence so that the battery unit 12A may be properly charged for the next landscaping session. A user of the system 10 may set operating parameters for the lawn mower 12. Using the I/O devices 36 of the charging unit 14, the user may set a schedule of when the user may plan to use the lawn mower 12 for landscaping. The user may set a desired charge level of the battery unit 12A which the user may want the battery unit 12A to be charged to immediately prior to the next landscaping session. For example, the user may want to landscape the property every other Saturday at 10:00 am. The user may want the battery unit 12A to be fully charged at 100% of capacity. Based on these settings, the charging unit 14 may calculate and plan when charging of the battery unit 12A should commence so that the battery unit 12A may be charged to the desired setting at the desired time for the next landscaping session. The controller 34 may use the current charge level, calculate the drain rate of the battery unit 12A, and calculate charging time to the desired charge level to determine when to charge the battery unit 12A so that the battery unit 12A may be charged to the desired setting at the desired time for the next landscaping session. The above may be given as an example. The user may set other operating parameters for the lawn mower 12 than those disclosed above.

Since the user may only landscape the property once or twice a month, the battery unit 12A of the lawn mower 12 may become a stranded power asset when the lawn mower 12 is not being used. Thus, the battery unit 12A may be used as a BESS when the lawn mower 12 is not being used. When used as a BESS, the battery unit 12A may provide power to devices within/around the building 18 and/or supply power back to the electrical grid via the transmission network 20.

The charging unit 14 may be able to monitor for power issues to the building 18. If the charging unit 14 determines that power to the building 18 may be disrupted, power from the battery unit 12A may be used to power desired devices within and around the building 18. The charging unit 14 may be programmed to direct power from the battery unit 12A back through the electrical system 16 to an outlet/device in and/or around the building 18.

The communication device 36 of the charging unit 14 may be used to receive data from the utility provider 22 about potential power disruption, rolling black outs, etc. Based on this information, the charging unit 14 may charge the battery unit 12A so that the battery unit 12A may be used to power desired devices within and around the building 18 when the power disruption arises. For example, if the utility provider 22 indicates that the area where the building 18 is located may experience a power disruption, such as rolling blackouts, from 1:00 pm-3:00 pm, the controller 34 may use the current charge level, calculate the drain rate of the battery unit 12A, and calculate charging time so the battery unit 12A may be at the upper level of the desired charge level range or fully charged at 100% immediately prior to the announced time of the power disruption. If the power disruption does occur, the battery unit 12A may be used to power desired devices within and around the building 18.

The communication device 26 may receive data about a time when the utility provider 22 may experience high power demand. Based on this data, the charging unit 14 may be used to connect the battery unit 12A back to the transmission network 20 to try and lessen the high-power demand. Thus, the charging unit 14 may allow for bidirectional power flow. For example, if the utility provider 22 indicates that the due to high temperatures, the utility provider 22 may experience high-power demand which may overload the electrical grid from 1:00 pm to 5:00 pm, the controller 34 may use the current charge level, calculate the drain rate of the battery unit 12A, and calculate charging time so the battery unit 12A may be at the upper level of the desired charge level range and or fully charged at 100% immediately prior to the time the utility provider 22 has indicated the chance for high-power demand. The charging unit 14 may then connect the battery unit 12A the battery unit 12A back to the transmission network 20.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A method for a charging unit to charge and discharge a battery unit of an electric lawn mower, comprising:
connecting the electric lawn mower to the charging unit; and
using the battery unit of the electric lawn mower as a bi-directional power source, the charging unit directing power from the battery unit of the electric lawn mower in a first direction to be used as a back-up power supply for a device and in a second direction back to an electrical grid; and
calculating a charge plan so the battery unit is charged at a predefined level at a predefined time for a next landscaping session based on a battery drain rate of the battery unit and charging at an off-peak usage time of a provider of the electrical grid.

2. The method of claim 1, wherein calculating the charge plan comprises:
scheduling a date and time the lawn mower is to be used for the next landscaping session;
calculating by the charging unit a charging date and time when to charge the battery unit so the battery unit is fully charged at the scheduled date and time based on the battery drain rate and charging at the off-peak usage time of the provider of the electrical grid; and
charging the battery unit at the calculated charging date and time.

3. The method of claim 1, wherein calculating the charge plan comprises:
determining a desired charging level range of the battery unit by the charging unit to prolong a life of the battery unit;
determining a current charge level of the battery unit by the charging unit; and
maintaining the current charge level of the battery unit within the desired charging level range by the charging unit based on the battery drain rate and charging at the off-peak usage time of the provider of the electrical grid.

4. The method of claim 1, wherein calculating the charge plan comprises:
determining a desired charging level range of the battery unit by the charging unit to prolong a life of the battery unit;
determining a current charge level of the battery unit by the charging unit; and
discharging the battery unit when the current charge level of the battery unit is above the desired charging level range.

5. The method of claim 1, wherein calculating the charge plan comprises:
determining a desired charging level range of the battery unit by the charging unit to prolong a life of the battery unit;
determining a current charge level of the battery unit by the charging unit;
calculating when the current charge level falls below the desired charging level range by the charging unit; and
charging the battery unit prior to the current charge level of the battery unit falling below the desired charging level range based on the battery drain rate and charging at the off-peak usage time of the provider of the electrical grid.

6. (canceled)

7. The method of claim 1, wherein calculating the charge plan comprises:
monitoring for a power disruption on the electrical grid by the charging unit; and
connecting the battery unit to the device when the power disruption is monitored.

8. The method of claim 1, wherein calculating the charge plan comprises:
monitoring for a power disruption on the electrical grid by the charging unit; and
connecting the battery unit to the electrical grid when the power disruption is monitored.

9. The method of claim 1, wherein calculating the charge plan comprises:
receiving data from a utility provider of a planned power disruption;
charging the battery unit prior to the planned power disruption based on the battery drain rate and charging at the off-peak usage time of the provider of the electrical grid; and
connecting the battery unit to the electrical grid when the planned power disruption occurs.

10. The method of claim 3, wherein the desired charging level range of the battery unit is between 20% to 80% of a fully charged battery unit.

11. A method for a charging unit to charge and discharge a battery unit of an electric lawn mower, comprising:
connecting the electric lawn mower to the charging unit;
determining a desired charging level range of the battery unit by the charging unit to prolong a life of the battery unit;
scheduling a date and time on the charging unit when the lawn mower is to be used for landscaping;
entering a landscaping charge level of the battery unit on the charging unit;
calculating by the charging unit a charging date and time when to charge the battery unit so the battery unit is charged to the landscaping charge level at the scheduled date and time based on a battery drain rate and charging at an off-peak usage time of an electrical provider;
charging the battery unit at the calculated charging date and time;
determining a current charge level of the battery unit by the charging unit;
maintaining the current charge level of the battery unit within the desired charging level range by the charging unit time based on the battery drain rate and charging at the off-peak usage time of the electrical provider unless scheduled for landscaping and to be charged to the landscaping charge level; and
using the battery unit of the electric lawn mower as a bi-directional power source when the lawn mower is not being used for landscaping, the charging unit directing power from the battery unit of the electric lawn mower in a first direction to be used as a back-up power supply for a device and in a second direction back to an electrical grid of the electrical provider.

12. The method of claim 11, comprising discharging the battery unit when the current charge level of the battery unit is above the desired charging level range and the date and time for landscaping is above a predetermined timeframe.

13. The method of claim 11, comprising:
calculating when the current charge level falls below the desired charging level range by the charging unit; and
charging the battery unit prior to the current charge level of the battery unit falling below the desired charging level range based on the battery drain rate and charging at the off-peak usage time of the electrical provider u.

14. (canceled)

15. The method of claim 11, comprising:
monitoring for a power disruption on the electrical grid by the charging unit; and
connecting the battery unit to the device when the power disruption is monitored.

16. The method of claim 11, comprising:
monitoring for a power disruption on the electrical grid by the charging unit; and
connecting the battery unit to the electrical grid when the power disruption is monitored.

17. The method of claim 11, comprising:
receiving data from a utility provider of a planned power disruption;
charging the battery unit prior to the planned power disruption based on the battery drain rate and charging at the off-peak usage time of the electrical provider; and
connecting the battery unit to the electrical grid when the planned power disruption occurs.

18. A method for a charging unit to charge and discharge a battery unit of an electric lawn mower, comprising:
connecting the electric lawn mower to the charging unit;
scheduling a date and time the lawn mower is to be used for landscaping;
entering a landscaping charge level of the battery unit on the charging unit;
calculating by the charging unit a charging date and time when to charge the battery unit so the battery unit is charged to the landscaping charge level at the scheduled date and time based on a battery drain rate and charging at an off-peak usage time of an electrical provider;
charging the battery unit at the calculated charging date and time so the battery unit is charged to the landscaping charge level;
determining a current charge level of the battery unit by the charging unit;
determining a desired charging level range of the battery unit by the charging unit to prolong a life of the battery unit;
discharging the battery unit when the current charge level of the battery unit is above the desired charging level range and the date and time for landscaping is above a predetermined timeframe;
calculating when the current charge level falls below the desired charging level range by the charging unit;
charging the battery unit prior to the current charge level of the battery unit falling below the desired charging level range based on the battery drain rate and charging at the off-peak usage time of the electrical provider unless the date and time for landscaping is within a predetermined timeframe; and
using the battery unit of the electric lawn mower as a bi-directional power source, the charging unit directing power from the battery unit of the electric lawn mower in a first direction to be used as a back-up power supply for a device and in a second direction back to an electrical grid.

19. The method of claim 18, comprising:
monitoring for a power disruption on the electrical grid by the charging unit; and
connecting the battery unit to the device when the power disruption is monitored.

20. The method of claim 1, comprising:
receiving data from a utility provider of a planned power disruption;
charging the battery unit prior to the planned power disruption; and
connecting the battery unit to the electrical grid when the planned power disruption occurs.
